(19) United States
(12) Patent Application Publication
(10) Pub. No.: US 2016/0315866 A1
(43) Pub. Date: Oct. 27, 2016

(54) SERVICE BASED INTELLIGENT PACKET-IN MECHANISM FOR OPENFLOW SWITCHES

(71) Applicant: Telefonaktiebolaget L M Ericsson (publ), Stockholm (SE)

(72) Inventors: Vishal Thapar, Bangalore (IN); Faseela K., Bangalore (IN)

(21) Appl. No.: 14/697,397

(22) Filed: Apr. 27, 2015

(51) Int. Cl. H04L 12/851; H04L 12/26; H04L 12/721

(52) U.S. Cl. CPC H04L 47/2408; H04L 45/38; H04L 43/18; H04L 43/10

(57) ABSTRACT

A method is performed by a network device for performing controller-specific output actions. The network device is coupled to a plurality of controllers in a software defined network. The method includes receiving a controller identifier advertisement from a controller of the plurality of controllers, associating the controller identifier with a communication channel to the controller, generating a flow entry that includes a packet matching criteria and an output action that specifies the controller identifier, receiving a packet, determining whether the packet matches the packet matching criteria of the flow entry, and upon determining that the packet matches the packet matching criteria of the flow entry, determining the communication channel associated with the controller identifier specified by the output action of the flow entry and transmitting the packet to the controller via the communication channel.

### FIELD

Embodiments of the invention relate to the field of software defined networking. More specifically, the embodiments of the invention relate to controller-specific output actions in a software defined network.

### BACKGROUND

Software Defined Networking (SDN) is an approach to computer networking that employs a split architecture network in which the forwarding (data) plane is decoupled from the control plane. The use of a split architecture network simplifies the network devices (e.g., switches) implementing the forwarding plane by shifting the intelligence of the network into one or more controllers that oversee the switches. SDN facilitates rapid and open innovation at the network layer by providing a programmable network infrastructure.

OpenFlow is a protocol that enables controllers and switches in a software defined network to communicate with each other. OpenFlow enables dynamic programming of flow control policies in the network. An OpenFlow switch may establish communication with a single controller or may establish communication with multiple controllers. Connecting to multiple controllers improves reliability, as the OpenFlow switch can continue to operate in OpenFlow mode even if a controller fails or a connection to a controller fails. Handover of switches between controllers is managed by the controllers, which enables fast recovery from failure and also load balancing among controllers.

In a multiple controller environment, the controllers have very little control over the Packet-In messages received from the switches. Typically, all controllers will receive all Packet-In messages from the switches, or using the OpenFlow Asynchronous Configuration, a controller can specify for which Packet-In messages to listen. However, there is no mechanism for a switch to transmit packets to a specific controller, for example, based on the type of service with which the packet is associated.

### SUMMARY

A method is performed by a network device for performing controller-specific output actions. The network device is coupled to a plurality of controllers in a software defined network. The method includes receiving a controller identifier advertisement from a controller of the plurality of controllers, associating the controller identifier with a communication channel to the controller, generating a flow entry that includes a packet matching criteria and an output action that specifies the controller identifier, receiving a packet, determining whether the packet matches the packet matching criteria of the flow entry, and upon determining that the packet matches the packet matching criteria of the flow entry, determining the communication channel associated with the controller identifier specified by the output action of the flow entry and transmitting the packet to the controller via the communication channel.

A network device is configured to perform controller-specific output actions in a software defined network that is managed by a plurality of controllers. The network device includes a non-transitory machine readable storage medium to store a controller-specific output action component. The network device also includes a processor that is communicatively coupled to the non-transitory machine readable storage medium. The processor is configured to execute the controller-specific output action component. The controller-specific output action component is configured to associate a controller identifier with a communication channel to a controller of the plurality of controllers that advertised the controller identifier, generate a flow entry that includes a packet matching criteria and an output action that specifies the controller identifier, determine whether a received packet matches the packet matching criteria of the flow entry, and upon a determination that the packet matches the packet matching criteria of the flow entry, determine the communication channel associated with the controller identifier specified by the output action of the flow entry for transmitting the packet to the controller.

A non-transitory computer readable medium has stored therein instructions to be executed by a network device for performing controller-specific output actions when the network device is coupled to a plurality of controllers in a software defined network. The instructions, when executed by the network device, cause the network device to perform a set of operations including, receiving a controller identifier advertisement from a controller of the plurality of controllers, associating the controller identifier with a communication channel to the controller, generating a flow entry that includes a packet matching criteria and an output action that specifies the controller identifier, receiving a packet, determining whether the packet matches the packet matching criteria of the flow entry, and upon determining that the packet matches the packet matching criteria of the flow entry, determining the communication channel associated with the controller identifier specified by the output action of the flow entry and transmitting the packet to the controller via the communication channel.

A computing device implements a plurality of software containers for implementing network function virtualization (NFV), where a software container from the plurality of software containers is configured to implement a virtual switch that performs controller-specific output actions in a software defined network that is managed by a plurality of controllers. The computing device includes a storage medium to store a controller-specific output action component and a processor communicatively coupled to the storage medium. The processor is configured to execute the software container, where the software container is configured to implement the controller-specific output action component. The controller-specific output action component is configured to associate a controller identifier with a communication channel to a controller of the plurality of controllers that advertised the controller identifier, generate a flow entry that includes a packet matching criteria and an output action that specifies the controller identifier, determine whether a received packet matches the packet matching criteria of the flow entry, and upon a determination that the packet matches the packet matching criteria of the flow entry, determine the communication channel associated with the controller identifier specified by the output action of the flow entry for transmitting the packet to the controller.

A method is performed by a controller in a software defined network for supporting controller-specific output actions. The method includes transmitting a controller identifier advertisement to a network device and transmitting an instruction to the network device to generate a flow entry that includes a packet matching criteria and an output action that specifies a controller identifier of one of a plurality of controllers in the software defined network.

A control plane device is configured to implement at least one centralized control plane for a software defined network. The centralized control plane is configured to support controller-specific output actions. The control plane device includes a non-transitory machine readable storage medium to store a controller-specific output action component. The control plane device also includes a processor that is communicatively coupled to the non-transitory machine readable storage medium. The processor is configured to execute the controller-specific output action component. The controller-specific output action component is configured to cause a controller identifier advertisement to be transmitted to a network device and cause an instruction to be transmitted to the network device to generate a flow entry that includes a packet matching criteria and an output action that specifies a controller identifier of one of a plurality of controllers in the software defined network.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a software defined network that implements controller-specific output actions.

FIG. 2 is a diagram illustrating one embodiment of a set of flow entries in a network device.

FIG. 3 is a flow diagram illustrating one embodiment of a process for performing controller-specific output actions, from the perspective of a network device (e.g., switch) in a software defined network.

FIG. 4 is a flow diagram illustrating one embodiment of a process for supporting controller-specific output actions, from the perspective of a controller in a software defined network.

FIG. 5A illustrates connectivity between network devices (NDs) within an exemplary network, as well as three exemplary implementations of the NDs, according to some embodiments of the invention.

FIG. 5B illustrates an exemplary way to implement a special-purpose network device according to some embodiments of the invention.

FIG. 5C illustrates various exemplary ways in which virtual network elements (VNEs) may be coupled according to some embodiments of the invention.

FIG. 5D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 5E illustrates the simple case of where each of the NDs implements a single NE, but a centralized control plane has abstracted multiple of the NEs in different NDs into (to represent) a single NE in one of the virtual network(s), according to some embodiments of the invention.

FIG. 5F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 6 illustrates a general purpose control plane device with centralized control plane (CCP) software, according to some embodiments of the invention.

### DESCRIPTION OF EMBODIMENTS

The following description describes methods and apparatus for performing controller-specific output actions in a software defined network. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Software defined networking (SDN) is a network architecture in which the control plane is decoupled from the forwarding plane. A SDN network (also called a software defined network) typically includes multiple forwarding elements (e.g., switches) interconnecting each other and one or more controllers that control the forwarding behavior of the switches. A controller can control the programming of flow tables in the switches to implement any forwarding protocol. A switch forwards packets from an ingress port to an egress port according to the rules in the flow tables. Each entry of a flow table (i.e., flow entry) includes a match field and a corresponding set of instructions. When an incoming packet matches the match field of a flow entry, the corresponding set of instructions are executed for that packet. The set of instructions may instruct the switch to perform various operations on the packet including, but not limited to, forwarding the packet to a given port, modifying certain bits in the packet header, encapsulating the packet, and dropping the packet. When the switch receives a packet for which there is no matching flow entry, the switch typically forwards the packet to the controller to be analyzed. The controller then decides how the packet should be handled. The controller may decide to drop the packet, or the controller can control programming of (e.g., transmit an instruction to generate) a flow entry by the switch directing forwarding of similar packets in the future.

The controller in a software defined network can instruct a switch to add, update, or delete flow entries in a flow table both reactively (e.g., in response to the controller receiving a packet from the switch) or proactively. Thus, software defined networking facilitates rapid innovation and deployment of network protocols by providing a programmable network infrastructure.

OpenFlow is a protocol that enables controllers and switches in a software defined network to communicate with each other. An OpenFlow switch may establish communication with a single controller or may establish communication with multiple controllers. Connecting to multiple controllers improves reliability, as the OpenFlow switch can continue to operate in OpenFlow mode even if a controller fails or a connection to a controller fails. Handover of switches between controllers is managed by the controllers, which enables fast recovery from failure and also load balancing among controllers.

Currently, when OpenFlow operation is initiated, the switch must connect to all controllers with which the switch is configured and try to maintain connectivity with all of these controllers concurrently. A switch transmits asynchronous messages such as a Packet-In message to all connected controllers. A Packet-In message transfers control of a packet to the controller. When a switch is connected to multiple controllers, the Packet-In message is duplicated for each controller. As such, in a multiple controller environment, the controllers have very little control over the Packet-In messages received from the switches. Typically, all controllers will receive all Packet-In messages from the switches, or using the OpenFlow Asynchronous Configuration, a controller can specify for which Packet-In messages to listen. However, there is no mechanism for a switch to transmit packets to a specific controller, for example, based on the type of service with which the packet is associated. For example, in a software defined network that has a cluster of three controllers, it may be desirable to have Address Resolution Protocol (ARP) packets handled by the first controller, Link Layer Discovery Protocol (LLDP) packets handled by the second controller, and Dynamic Host Configuration Protocol (DHCP) packets handled by the third controller. However, current OpenFlow specifications do not provide packet control at this level of granularity.

Embodiments of the invention provide benefits over the prior art by enabling a switch to transmit packets to a specific controller. Embodiments achieve this by configuring flow entries in the switch that include controller-specific output actions that instruct the switch to transmit matching packets to a specific controller. When a packet matches packet matching criteria of the flow entry, the switch transmits the packet to the specific controller specified by the corresponding output action of the flow entry. Each controller is identified by a controller identifier (ID), and this controller ID can be used when configuring the flow entry for transmitting packets to the controller. The ability to transmit packets to a specific controller provides additional flexibility and control over how packets are currently handled in a software defined network. For example, controller-specific output actions allow for switches to classify incoming packets based on their service and transmit these packets to a specific controller responsible for handling that service. Also, different services can be managed by different controllers based, for example, on the performance requirements of the services. For example, a computationally intensive service can be managed by a controller with 40 Gigabyte (GB) memory and 16 core Central Processing Units (CPUs), whereas a light-weight service can be managed by a controller with relatively less computing resources. It is to be noted that these are just a few exemplary applications of controller-specific output actions and that other applications as would occur to one having ordinary skill in the art are contemplated by this disclosure. Various embodiments will be described herein below in additional detail.

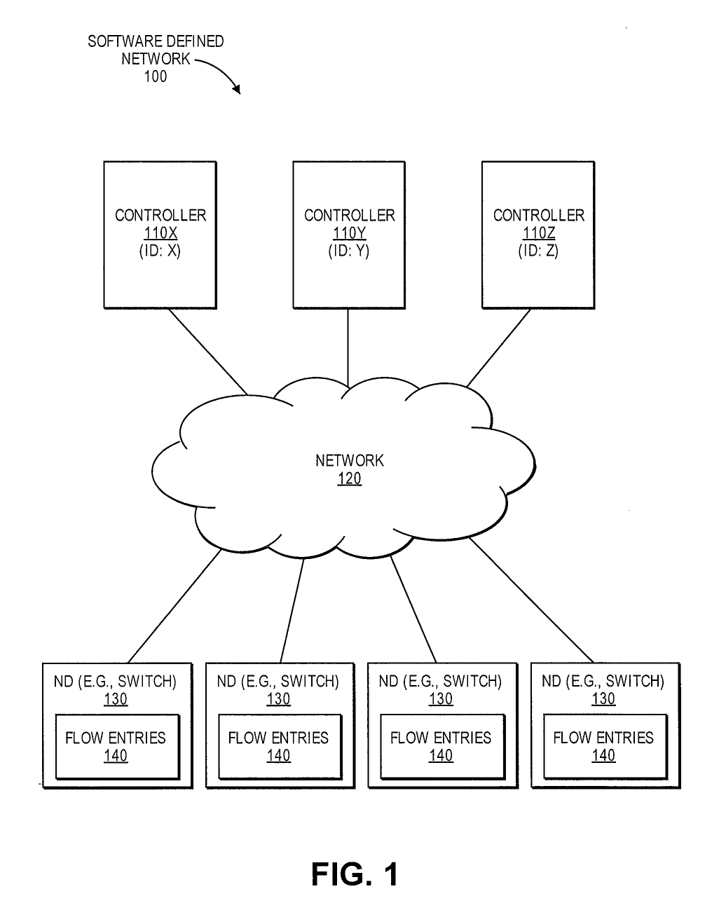

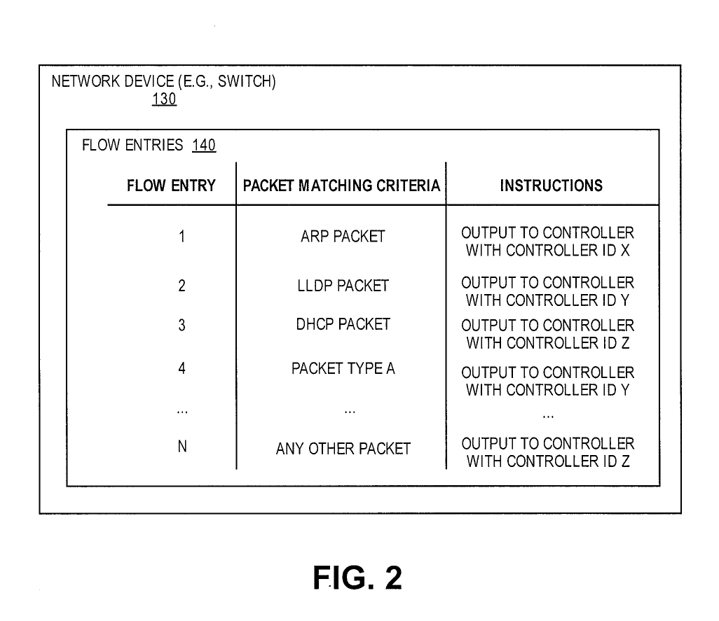

FIG. 1 is a diagram of one embodiment of a software defined network that implements controller-specific output actions. A simple network topology of a software defined network 100 that includes three controllers (i.e., 110X, 110Y, and 110Z) and four network devices (e.g., switches) 130 is illustrated in FIG. 1. Each of the controllers 110 may connect to the network devices 130 over a network 120. Each controller 110 is assigned a controller identifier (ID) that uniquely identifies the controller 110. Controller 110X is assigned controller ID X, controller 110Y is assigned controller ID Y, and controller 110Z is assigned controller ID Z. Each network device 130 includes a set of flow entries 140. In one embodiment, a flow entry includes a packet matching criteria (e.g., match field) and a corresponding set of instructions to execute when a packet matches the packet matching criteria. A packet is said to match a flow entry if the packet matches the packet matching criteria of the flow entry. The flow entries 140 are described in more detail herein below with reference to FIG. 2.

In one embodiment, the controllers 110 and the network devices 130 communicate using a version of OpenFlow (e.g., OpenFlow 1.3) as the communication protocol. In one embodiment, OpenFlow can be extended as described herein below to support controller-specific output actions in the software defined network. For clarity and ease of understanding, embodiments will primarily be described using OpenFlow (and extensions thereto) as the communication protocol between the controllers 110 and network devices 130. However, one having ordinary skill in the art will understand that the controllers 110 and network devices 130 can communicate using other types of protocols and that other protocols can be extended in a similar fashion to support controller-specific output actions.

In one embodiment, when a controller 110 and a network device 130 first establish a connection, the controller 110 transmits an OFPT_FEATURES_REQUEST message to the network device 130 requesting that the network device 130 identify capabilities/features supported by the network device 130. The network device 130 then responds to the controller with an OFPT_FEATURES_REPLY message that identifies the capabilities/features that the network device 130 supports. In OpenFlow 1.3, only certain capabilities/features are included as part of the OFPT_FEATURES_REPLY message, as defined by ofp_capabilities. In one embodiment, OpenFlow can be extended so that the controller 110 can be informed of additional capabilities/features of the network device 130 (e.g., vendor-specific capabilities). In one embodiment, the controller 110 transmits a VENDOR_SPECIFIC_SWITCH_FEATURES_REQUEST_message requesting that the network device 130 identify additional capabilities/features supported by the network device 130. The network device 130 then responds to the controller 110 with a VENDOR_SPECIFIC_SWITCH_FEATURES_REPLY message identifying additional capabilities/features that the network device 130 supports. In one embodiment, the VENDOR_SPECIFIC_SWITCH_FEATURES_REPLY message includes an indication that the network device 130 supports controller-specific output actions.

Upon determining that the network device 130 supports controller-specific output actions, the controller 110 transmits a CONTROLLER_ID_ADVERTISE message to the network device 130 advertising its controller ID to the network device 130. The controller ID uniquely identifies the controller 110 among a cluster of controllers. In one embodiment, the controller ID is a 64-bit value that uniquely identifies the controller 110. The network device 130 may perform a similar message exchange with other controllers 110 with which the network device 130 is connected to obtain the controller ID of each respective controller 110.

The network device 130 keeps track of the controller ID of each controller 110 with which the network device 130 is connected and a corresponding OpenFlow channel to that controller 110. The OpenFlow channel is used to exchange OpenFlow messages between the network device 130 and the controller 110. A controller 110 may control programming of a flow entry in the network device 130 by transmitting an OFPT_FLOW_MOD message to the network device 130. In one embodiment, the OFPT_FLOW_MOD message includes a packet matching criteria (e.g., match field) and an output action that specifies a controller ID. Whenever a packet matches this flow entry, the network device 130 determines the OpenFlow channel corresponding to the controller ID and forwards the packet only on that specific OpenFlow channel to the controller 110 identified by the controller ID (e.g., as an OpenFlow Packet-In message). As a result, a controller 110 can configure flow entries 140 in a network device 130 such that incoming packets at the network device 130 can be transmitted to a specific controller identified by a controller ID, instead of being transmitted to all controllers 110 with which the network device 130 is connected. This allows for a software defined network 100 to implement an asymmetric cluster of controllers 110, where each controller 110 can handle specific services.

In one embodiment, the following non-limiting structures can be used for the message exchange between the controller 110 and network device 130 to support controller-specific output actions. The exemplary structures extend OpenFlow to support controller-specific output actions.

VENDOR_SPECIFIC_SWITCH_FEATURES_REQUEST:

/* Experimenter extension. */
/* For Vendor Specific Switch Features Request, send exp_type is
VENDOR_TYPE_SWITCH_FEATURES_REQUEST */
struct ofp_experimenter_header {

struct ofp_header header; /* Type OFPT_EXPERIMENTER. */
uint32_t experimenter; /* Experimenter ID:

* - MSB 0: low-order bytes are IEEE OUI.
* - MSB != 0: defined by ONF. */

| | |
|---|---|
| uint32_t exp_type; | /* Experimenter defined. */ |

/* Experimenter-defined arbitrary additional data. */

};
OFP_ASSERT(sizeof(struct ofp_experimenter_header) == 16);

VENDOR_SPECIFIC_SWITCH_FEATURES_REPLY:

struct vendor_switch_features_reply {

| | |
|---|---|
| struct ofp_experimenter_header | exp_header; /* exp_type is |

VENDOR_TYPE_SWITCH_FEATURES_RESPONSE */

| | |
|---|---|
| uint64_t datapath_id; | /* Datapath unique ID.*/ |

| | |
|---|---|
| uint32_t length; | /* length of exp_capabilities in bytes */ |
| uint8_t pad[4]; | /* Align to 64 bits */ |

| /* Followed by length bytes containing the capabilities data */ | |
|---|---|
| uint8_t exp_capabilities[0]; | /* Bitmap of support “eric_switch_features_capabilities”. |

*/
};
OFP_ASSERT(sizeof(struct eric_switch_features_reply) == 32);

Common Header:

/* All messages in this extension use the following message header */
/* Common header for all messages */
struct vendor_header {

struct ofp_header header; /* OFPT_EXPERIMENTER. */
uint32_t experimenter; /* VENDOR_EXPERIMENTER_ID. */
uint32_t exp_type; /* One of MSG_TYPE_* above. */

};
OFP_ASSERT(sizeof(struct eric_header) ==
sizeof(struct ofp_experimenter_header));

CONTROLLER_ID_ADVERTISE:

/* Message structure for CONTROLLER_ID_ADVERTISE */
struct controller_id_advertise {

| struct ofp_header header; /* OFPT_EXPERIMENTER. */ | |
|---|---|
| uint32_t experimenter; /* VENDOR_EXPERIMENTER_ID. */ | |
| uint32_t exp_type; /* CONTROLLER_ID_ADVERTISE */ | |
| uint64_t controller_id; | /* Controller unique ID. The lower |

48-bits are for a MAC address, while the upper 16-bits are
implementer-defined. */

};
OFP_ASSERT(sizeof(struct eric_resync_request) ==
sizeof(struct eric_header) + 8);

Controller-Specific Output Action:

struct ofp_action_controller_specific_output {

uint16_t type; /* OFPAT_OUTPUT. */
uint16_t len; /* Length is 8. */
uint16_t port; /* CONTROLLER */
uint64_t controller_id /* controller to which the packet is to be
forwarded*/
uint16_t max_len; /* Max length to send to controller. */

};

FIG. 2 is a diagram illustrating one embodiment of a set of flow entries in a network device 130. In one embodiment, the programming of the flow entries 140 by the network device (e.g., switch) 130 is controlled by one or more controllers 110. Each flow entry includes a packet matching criteria and a corresponding set of instructions. When the network device 130 receives a packet that matches a packet matching criteria of a flow entry, the network device 130 executes the corresponding set of instructions of that flow entry. In this example, the network device 130 includes N flow entries. The first flow entry has a packet matching criteria that matches packets that are associated with an Address Resolution Protocol (ARP) service and a corresponding instruction to output (i.e., transmit/forward) matching packets to a controller identified by controller ID X. In one embodiment, the packet matching criteria identifies ARP packets by matching ETH_TYPE=0x806. If the network device 130 receives an ARP packet, the network device 130 will transmit this packet to the controller identified by controller ID X. The second flow entry has a packet matching criteria that matches packets that are associated with a Link Layer Discovery Protocol (LLDP) service and a corresponding instruction to output (i.e., transmit/forward) matching packets to a controller identified by controller ID Y. In one embodiment, the packet matching criteria identifies LLDP packets by matching ETH_TYPE=0x88cc. If the network device 130 receives a LLDP packet, the network device 130 will transmit this packet to the controller identified by controller ID Y. The third flow entry has a packet matching criteria that matches packets that are associated with a Dynamic Host Configuration Protocol (DHCP) service and a corresponding instruction to output (i.e., transmit/forward) matching packets to a controller identified by controller ID Z. In one embodiment, the packet matching criteria identifies DHCP packets by matching ETH_TYPE=0x800 (IP), IP_PROTO=0x11 (UDP), and UDP_SRC/UDP_DST=67/68, depending on client/server traffic. If the network device 130 receives a DHCP packet, the network device 130 will transmit this packet to the controller identified by controller ID Z. In one embodiment, a given controller 110 can handle packets for multiple services and/or multiple packet types. For example, the network device 130 can include a fourth flow entry that transmits packets that match packet type A (can be user-defined) to the controller identified by controller ID Y. As such, in this example, both LLDP packets and packets of packet type A will be transmitted to the controller identified by controller ID Y. Further, the network device 130 includes an Nth flow entry having a packet matching criteria that matches all other packets and a corresponding instruction to output (i.e., transmit/forward) matching packets to the controller identified by controller ID Z. In this way, a network device 130 can be configured to transmit packets associated with a given service or that match a given packet matching criteria to a particular controller 110. This allows for an asymmetric cluster of controllers 110, where each controller 110 handles specific services. In the example given above, the flow entries 140 of the network device 130 are configured such that ARP packets are transmitted to the controller responsible for handling ARP packets (i.e., controller 110X), LLDP packets are transmitted to the controller responsible for handling LLDP packets (i.e., controller 110Y), and DHCP packets are transmitted to the controller responsible for handling DHCP packets (i.e., controller 110Z). Furthermore, packets having packet type A, (which may be any user-defined packet matching criteria), are also transmitted to controller 110Y. Packets that do not match any of the above flow entries are transmitted to controller 110Z.

Controller-specific output actions can also be used to run computationally intensive applications on a separate dedicated controller 110. For example, a diagnostic or data-mining application running on a controller 110 may want to capture certain metadata from every Internet Protocol (IP) packet that passes through a network device 130. This type of application will likely overwhelm the controller 110 with a large amount of traffic, thereby impacting the controller's ability to make control plane decisions and react to any control plane events in the software defined network 100. In order to alleviate the burden on the controller 110, a second controller 110 can be provided that only runs the diagnostic or data-mining application. The network device 130 can then be programmed with a flow entry that transmits packets to the second controller 110 for diagnostic/data-mining purposes, while transmitting packets to a primary controller 110 for other services.

It is to be understood that the flow entries described herein are provided by way of example and not limitation, and that one having ordinary skill in the art will understand that the network device 130 can include any number of flow entries, and that the flow entries can have any desired packet matching criteria. Also, the instructions of a flow entry may include other instructions besides outputting (i.e., transmitting/forwarding) a packet to a specific controller 110. For example, a flow entry can include instructions to push/pop tags, modify packet header fields, change the time-to-live (TTL) of the packet, and other packet processing instructions.

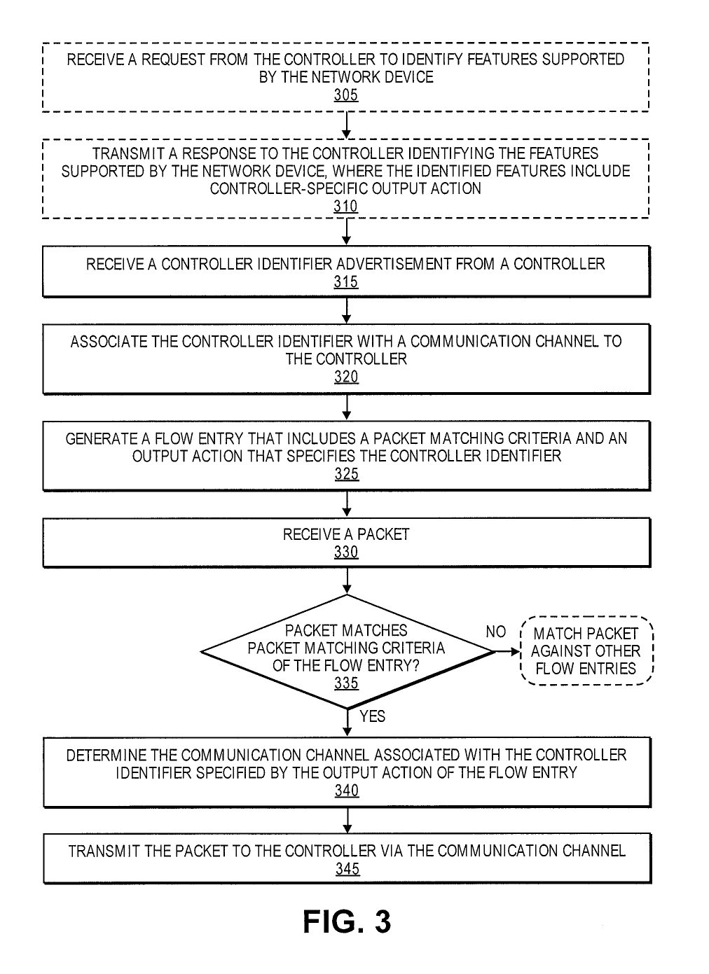

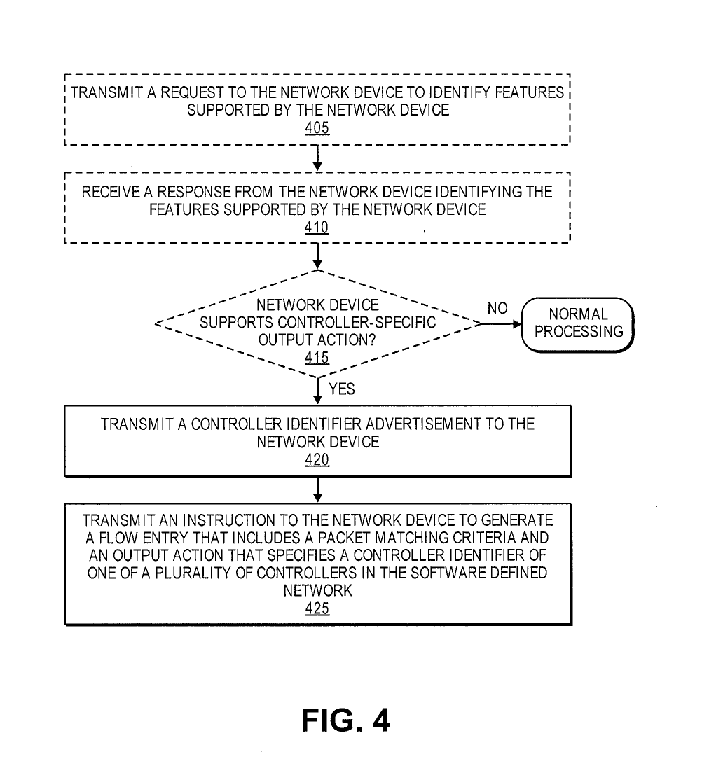

The operations in the flow diagrams of FIG. 3 and FIG. 4 will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

FIG. 3 is a flow diagram illustrating one embodiment of a process for performing controller-specific output actions, from the perspective of a network device (e.g., switch) in a software defined network. In one embodiment, the operations of the flow diagram may be performed by a network device 130 coupled to a plurality of controllers 110 in a software defined network 100. In one embodiment, the network device 130 and controllers 110 communicate using an extension to OpenFlow.

In one embodiment, the process is initiated when the network device 130 connects to a controller 110. In one embodiment, shortly after establishing a connection to the controller 110, the network device 130 receives a request from the controller 110 to identify features supported by the network device (block 305). In one embodiment, the request is in the form of the VENDOR_TYPE_SWITCH_FEATURES_REQUEST structure described above, or similar structure. The network device 130 then transmits a response to the controller 110 identifying the features supported by the network device 130 (block 310). In one embodiment, the features supported by the network device 130 are identified as part of the VENDOR_SPECIFIC_SWITCH_FEATURES_REPLY structure described above, or similar structure. If the network device 130 supports controller-specific output action features, the response transmitted to the controller 110 will include an indication that the network device 130 supports controller-specific output actions.

The network device 130 receives a controller ID advertisement from the controller 110 (block 315). The controller ID uniquely identifies the controller 110 among a cluster of controllers. In one embodiment, the controller ID is a 64-bit value that uniquely identifies the controller 110. In one embodiment, 48 bits of the controller ID is a media access control (MAC) address of the controller 110, while the remaining bits are implementer-defined. In one embodiment, the controller ID advertisement is in the form of the CONROLLER_ID_ADVERTISE structure described above, or similar structure. The network device 130 associates the controller ID with a communication channel to the controller 110 (block 320). The network device 130 may keep track of an association between the controller ID of controllers and their corresponding communication channels. In one embodiment, the communication channel to the controller is an OpenFlow channel.

The network device 130 generates a flow entry that includes a packet matching criteria and an output action that specifies the controller ID (block 325). In one embodiment, the flow entry is generated in response to receiving an instruction from a controller 110 to program the flow entry. The instruction to program the flow entry can come from any controller 110 with which the network device 130 is connected. In one embodiment, the output action of the flow entry is in the form of the Controller-Specific Output Action structure described above, or similar structure. In one embodiment, the packet matching criteria matches packets that are associated with a given service such as an Address Resolution Protocol (ARP) service, a Link Layer Discovery Protocol (LLDP) service, or a Dynamic Host Configuration Protocol (DHCP) service. In one embodiment, the packet matching criteria matches packets that are to be diagnosed by a controller that runs a diagnostic application. In this embodiment, the corresponding output action specifies the controller ID of the controller 110 running the diagnostic application. The flow entries described above are provided by way of example and not limitation. It should be understood that the network device 130 can program a flow entry having any desired packet matching criteria.

When the network device 130 receives a packet (block 330), it determines whether the packet matches the packet matching criteria of the flow entry (decision block 335). If the packet does not match the flow entry, then the network device 130 attempts to match the incoming packet against other flow entries in the network device 130, as needed. If the packet matches the flow entry, then the network device 130 determines the communication channel associated with the controller ID specified by the output action of the flow entry (block 340). The network device 130 then transmits the packet to the controller 110 via the communication channel (i.e., communication channel associated with the controller ID specified by the output action of the flow entry) (block 345). The network device 130 can repeat blocks 330-345 for each packet that the network device 130 receives to output (i.e., transmit/forward) the packet to the appropriate controller 110 or otherwise process the packet.

As a result of the processes described herein, the network device 130 can be programmed by a controller 110 to transmit packets matching a given criteria to a specific controller 110 (identified by a controller ID). In this fashion, the network device 130 can be programmed with flow entries that define which packets should be handled by which specific controller 110.

FIG. 4 is a flow diagram illustrating one embodiment of a process for supporting controller-specific output actions, from the perspective of a controller in a software defined network. In one embodiment, the operations of the flow diagram may be performed by a controller 110 that controls one or more network devices (e.g., switches) 130 in a software defined network 100. In one embodiment, the controller 110 and the network devices 130 communicate using an extension to OpenFlow.

In one embodiment, the process is initiated when a network device 130 connects to a controller 110. In one embodiment, shortly after establishing a connection to the network device 130, the controller 110 transmits a request to the network device 130 to identify features supported by the network device 130 (block 405). In one embodiment, the request is in the form of the VENDOR_TYPE_SWITCH_FEATURES_REQUEST structure described above, or similar structure. The controller 110 then receives a response from the network device 130 identifying the features supported by the network device 130 (block 410). In one embodiment, the features supported by the network device are identified as part of the VENDOR_SPECIFIC_SWITCH_FEATURES_REPLY structure described above, or similar structure. If the network device 130 supports controller-specific output action features, the response received by the controller 110 will include an indication that the network device 130 supports controller-specific output actions. The controller 110 then determines whether the network device 130 supports controller-specific output action features (decision block 415). If the network device 130 does not support controller-specific output action features, then the controller 110 proceeds with normal processing (i.e., without controller-specific output action features).

If the network device 130 supports controller-specific output action features, then the controller 110 transmits a controller ID advertisement to the network device 130 (block 420). The controller ID advertisement includes the controller ID of the controller 110. In one embodiment, the controller ID advertisement is in the form of the CONROLLER_ID_ADVERTISE structure described above, or similar structure. The controller 110 transmits an instruction to the network device 130 to generate a flow entry that includes a packet matching criteria and an output action that specifies a controller ID of one of a plurality of controllers 110 in the software defined network 100 (block 425). In one embodiment, the output action is in the form of the Controller-Specific Output Action structure described above, or similar structure. In one embodiment, the packet matching criteria is associated with a service such as an ARP service, LLDP service, DHCP service, or other type of service. In one embodiment, the packet matching criteria and output action is defined as desired by a user or network administrator of the software defined network. As a result of the processes described herein, a controller 110 can program a network device 130 to transmit packets matching a given criteria to a specific controller 110 (identified by a controller ID).

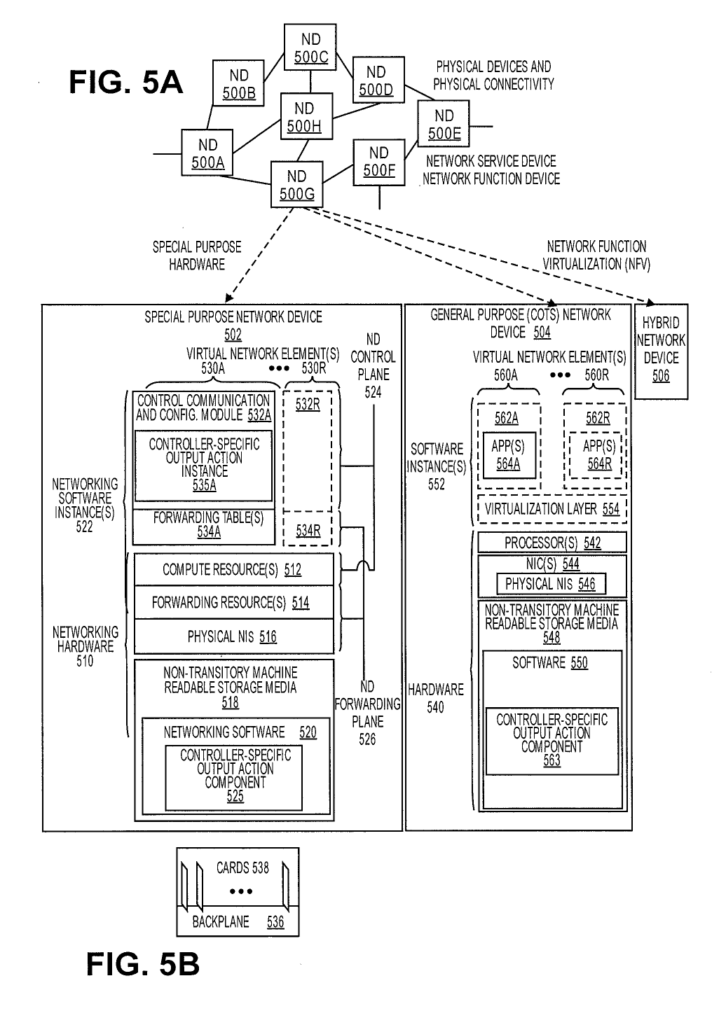

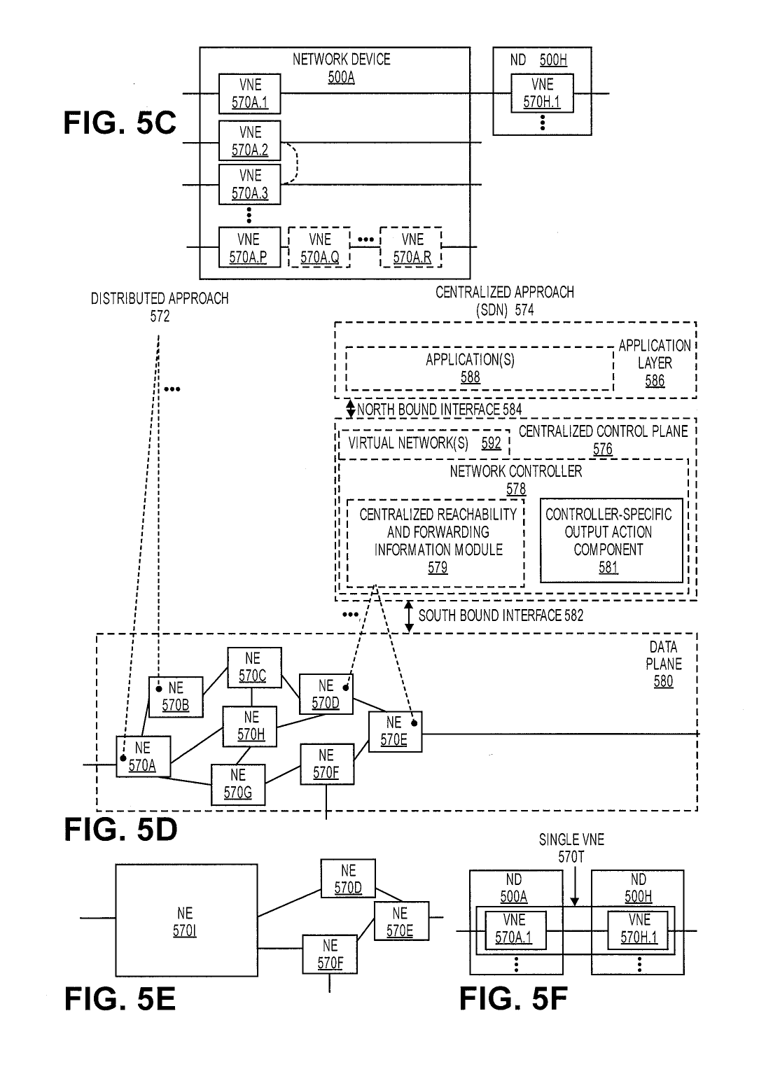

FIG. 5A illustrates connectivity between network devices (NDs) within an exemplary network, as well as three exemplary implementations of the NDs, according to some embodiments of the invention. FIG. 5A shows NDs 500A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 500A, E, and F illustrates that these NDs act as ingress and egress points for the network (and thus, these NDs are sometimes referred to as edge NDs; while the other NDs may be called core NDs).

Two of the exemplary ND implementations in FIG. 5A are: 1) a special-purpose network device 502 that uses custom application-specific integrated-circuits (ASICs) and a proprietary operating system (OS); and 2) a general purpose network device 504 that uses common off-the-shelf (COTS) processors and a standard OS.

The special-purpose network device 502 includes networking hardware 510 comprising compute resource(s) 512 (which typically include a set of one or more processors), forwarding resource(s) 514 (which typically include one or more ASICs and/or network processors), and physical network interfaces (NIs) 516 (sometimes called physical ports), as well as non-transitory machine readable storage media 518 having stored therein networking software 520, such as controller-specific output action component 525. In one embodiment, the controller-specific output action component 525 implements embodiments of the controller-specific output action processes described herein above. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 500A-H. During operation, the networking software 520 may be executed by the networking hardware 510 to instantiate a set of one or more networking software instance(s) 522. In one embodiment, execution of the networking software 520 instantiates a controller-specific output action instance 535A for performing embodiments of the controller-specific output action processes described herein above. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A).

The special-purpose network device 502 is often physically and/or logically considered to include: 1) a ND control plane 524 (sometimes referred to as a control plane) comprising the compute resource(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the compute resource(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R.

FIG. 5B illustrates an exemplary way to implement the special-purpose network device 502 according to some embodiments of the invention. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec) (RFC 4301 and 4309), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors) and network interface controller(s) 544 (NICs; also known as network interface cards) (which include physical NIs 546), as well as non-transitory machine readable storage media 548 having stored therein software 550. Software 550 includes a controller-specific output action component 563 that implements embodiments of the controller-specific output action processes described herein above. During operation, the processor(s) 542 execute the software 550 to instantiate one or more sets of one or more applications 564A-R. While one embodiment does not implement virtualization, alternative embodiments may use different forms of virtualization—represented by a virtualization layer 554 and software containers 562A-R. For example, one such alternative embodiment implements operating system-level virtualization, in which case the virtualization layer 554 represents the kernel of an operating system (or a shim executing on a base operating system) that allows for the creation of multiple software containers 562A-R that may each be used to execute one of the sets of applications 564A-R. In this embodiment, the multiple software containers 562A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 554 represents a hypervisor (sometimes referred to as a virtual machine monitor (VMM)) or a hypervisor executing on top of a host operating system; and 2) the software containers 562A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 564A-R, as well as the virtualization layer 554 and software containers 562A-R if implemented, are collectively referred to as software instance(s) 552. Each set of applications 564A-R, corresponding software container 562A-R if implemented, and that part of the hardware 540 that executes them (be it hardware dedicated to that execution and/or time slices of hardware temporally shared by software containers 562A-R), forms a separate virtual network element(s) 560A-R. In one embodiment, the software containers 562A-R execute the controller-specific output action component 563 to perform embodiments of the controller-specific output action processes described herein above.

The virtual network element(s) 560A-R perform similar functionality to the virtual network element(s) 530A-R—e.g., similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the software container(s) 562A-R differently. For example, while embodiments of the invention are illustrated with each software container 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 562A-R to VNEs also apply to embodiments where such a finer level of granularity is used.

In certain embodiments, the virtualization layer 554 includes a virtual switch that provides similar forwarding services as a physical Ethernet switch. Specifically, this virtual switch forwards traffic between software containers 562A-R and the NIC(s) 544, as well as optionally between the software containers 562A-R; in addition, this virtual switch may enforce network isolation between the VNEs 560A-R that by policy are not permitted to communicate with each other (e.g., by honoring virtual local area networks (VLANs)).

The third exemplary ND implementation in FIG. 5A is a hybrid network device 506, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP) (RFC 768, 2460, 2675, 4113, and 5405), Transmission Control Protocol (TCP) (RFC 793 and 1180), and differentiated services (DSCP) values (RFC 2474, 2475, 2597, 2983, 3086, 3140, 3246, 3247, 3260, 4594, 5865, 3289, 3290, and 3317).

FIG. 5C illustrates various exemplary ways in which VNEs may be coupled according to some embodiments of the invention. FIG. 5C shows VNEs 570A.1-570A.P (and optionally VNEs 570A.Q-570A.R) implemented in ND 500A and VNE 570H.1 in ND 500H. In FIG. 5C, VNEs 570A.1-P are separate from each other in the sense that they can receive packets from outside ND 500A and forward packets outside of ND 500A; VNE 570A.1 is coupled with VNE 570H.1, and thus they communicate packets between their respective NDs; VNE 570A.2-570A.3 may optionally forward packets between themselves without forwarding them outside of the ND 500A; and VNE 570A.P may optionally be the first in a chain of VNEs that includes VNE 570A.Q followed by VNE 570A.R (this is sometimes referred to as dynamic service chaining, where each of the VNEs in the series of VNEs provides a different service—e.g., one or more layer 4-7 network services). While FIG. 5C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 5A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 5A may also host one or more such servers (e.g., in the case of the general purpose network device 504, one or more of the software containers 562A-R may operate as servers; the same would be true for the hybrid network device 506; in the case of the special-purpose network device 502, one or more such servers could also be run on a virtualization layer executed by the compute resource(s) 512); in which case the servers are said to be co-located with the VNEs of that ND.

A virtual network is a logical abstraction of a physical network (such as that in FIG. 5A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN RFC 4364) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 5D illustrates a network with a single network element on each of the NDs of FIG. 5A, and within this straight forward approach contrasts a traditional distributed approach (commonly used by traditional routers) with a centralized approach for maintaining reachability and forwarding information (also called network control), according to some embodiments of the invention. Specifically, FIG. 5D illustrates network elements (NEs) 570A-H with the same connectivity as the NDs 500A-H of FIG. 5A.

FIG. 5D illustrates that the distributed approach 572 distributes responsibility for generating the reachability and forwarding information across the NEs 570A-H; in other words, the process of neighbor discovery and topology discovery is distributed.

For example, where the special-purpose network device 502 is used, the control communication and configuration module(s) 532A-R of the ND control plane 524 typically include a reachability and forwarding information module to implement one or more routing protocols (e.g., an exterior gateway protocol such as Border Gateway Protocol (BGP) (RFC 4271), Interior Gateway Protocol(s) (IGP) (e.g., Open Shortest Path First (OSPF) (RFC 2328 and 5340), Intermediate System to Intermediate System (IS-IS) (RFC 1142), Routing Information Protocol (RIP) (version 1 RFC 1058, version 2 RFC 2453, and next generation RFC 2080)), Label Distribution Protocol (LDP) (RFC 5036), Resource Reservation Protocol (RSVP) (RFC 2205, 2210, 2211, 2212, as well as RSVP-Traffic Engineering (TE): Extensions to RSVP for LSP Tunnels RFC 3209, Generalized Multi-Protocol Label Switching (GMPLS) Signaling RSVP-TE RFC 3473, RFC 3936, 4495, and 4558)) that communicate with other NEs to exchange routes, and then selects those routes based on one or more routing metrics. Thus, the NEs 570A-H (e.g., the compute resource(s) 512 executing the control communication and configuration module(s) 532A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 524. The ND control plane 524 programs the ND forwarding plane 526 with information (e.g., adjacency and route information) based on the routing structure(s). For example, the ND control plane 524 programs the adjacency and route information into one or more forwarding table(s) 534A-R (e.g., Forwarding Information Base (FIB), Label Forwarding Information Base (LFIB), and one or more adjacency structures) on the ND forwarding plane 526. For layer 2 forwarding, the ND can store one or more bridging tables that are used to forward data based on the layer 2 information in that data. While the above example uses the special-purpose network device 502, the same distributed approach 572 can be implemented on the general purpose network device 504 and the hybrid network device 506.

FIG. 5D illustrates that a centralized approach 574 (also known as software defined networking (SDN)) that decouples the system that makes decisions about where traffic is sent from the underlying systems that forwards traffic to the selected destination. The illustrated centralized approach 574 has the responsibility for the generation of reachability and forwarding information in a centralized control plane 576 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 576 has a south bound interface 582 with a data plane 580 (sometime referred to the infrastructure layer, network forwarding plane, or forwarding plane (which should not be confused with a ND forwarding plane)) that includes the NEs 570A-H (sometimes referred to as switches, forwarding elements, data plane elements, or nodes). The centralized control plane 576 includes a network controller 578, which includes a centralized reachability and forwarding information module 579 that determines the reachability within the network and distributes the forwarding information to the NEs 570A-H of the data plane 580 over the south bound interface 582 (which may use the OpenFlow protocol). Thus, the network intelligence is centralized in the centralized control plane 576 executing on electronic devices that are typically separate from the NDs. In one embodiment, the network controller 578 may include a controller-specific output action component 581 that implements embodiments of the controller-specific output action processes described herein above.

For example, where the special-purpose network device 502 is used in the data plane 580, each of the control communication and configuration module(s) 532A-R of the ND control plane 524 typically include a control agent that provides the VNE side of the south bound interface 582. In this case, the ND control plane 524 (the compute resource(s) 512 executing the control communication and configuration module(s) 532A-R) performs its responsibility for participating in controlling how data (e.g., packets) is to be routed (e.g., the next hop for the data and the outgoing physical NI for that data) through the control agent communicating with the centralized control plane 576 to receive the forwarding information (and in some cases, the reachability information) from the centralized reachability and forwarding information module 579 (it should be understood that in some embodiments of the invention, the control communication and configuration module(s) 532A-R, in addition to communicating with the centralized control plane 576, may also play some role in determining reachability and/or calculating forwarding information—albeit less so than in the case of a distributed approach; such embodiments are generally considered to fall under the centralized approach 574, but may also be considered a hybrid approach).

While the above example uses the special-purpose network device 502, the same centralized approach 574 can be implemented with the general purpose network device 504 (e.g., each of the VNE 560A-R performs its responsibility for controlling how data (e.g., packets) is to be routed (e.g., the next hop for the data and the outgoing physical NI for that data) by communicating with the centralized control plane 576 to receive the forwarding information (and in some cases, the reachability information) from the centralized reachability and forwarding information module 579; it should be understood that in some embodiments of the invention, the VNEs 560A-R, in addition to communicating with the centralized control plane 576, may also play some role in determining reachability and/or calculating forwarding information—albeit less so than in the case of a distributed approach) and the hybrid network device 506. In fact, the use of SDN techniques can enhance the NFV techniques typically used in the general purpose network device 504 or hybrid network device 506 implementations as NFV is able to support SDN by providing an infrastructure upon which the SDN software can be run, and NFV and SDN both aim to make use of commodity server hardware and physical switches.

FIG. 5D also shows that the centralized control plane 576 has a north bound interface 584 to an application layer 586, in which resides application(s) 588. The centralized control plane 576 has the ability to form virtual networks 592 (sometimes referred to as a logical forwarding plane, network services, or overlay networks (with the NEs 570A-H of the data plane 580 being the underlay network)) for the application(s) 588. Thus, the centralized control plane 576 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 5D shows the distributed approach 572 separate from the centralized approach 574, the effort of network control may be distributed differently or the two combined in certain embodiments of the invention. For example: 1) embodiments may generally use the centralized approach (SDN) 574, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 574, but may also be considered a hybrid approach.

While FIG. 5D illustrates the simple case where each of the NDs 500A-H implements a single NE 570A-H, it should be understood that the network control approaches described with reference to FIG. 5D also work for networks where one or more of the NDs 500A-H implement multiple VNEs (e.g., VNEs 530A-R, VNEs 560A-R, those in the hybrid network device 506). Alternatively or in addition, the network controller 578 may also emulate the implementation of multiple VNEs in a single ND. Specifically, instead of (or in addition to) implementing multiple VNEs in a single ND, the network controller 578 may present the implementation of a VNE/NE in a single ND as multiple VNEs in the virtual networks 592 (all in the same one of the virtual network(s) 592, each in different ones of the virtual network(s) 592, or some combination). For example, the network controller 578 may cause an ND to implement a single VNE (a NE) in the underlay network, and then logically divide up the resources of that NE within the centralized control plane 576 to present different VNEs in the virtual network(s) 592 (where these different VNEs in the overlay networks are sharing the resources of the single VNE/NE implementation on the ND in the underlay network).

On the other hand, FIGS. 5E and 5F respectively illustrate exemplary abstractions of NEs and VNEs that the network controller 578 may present as part of different ones of the virtual networks 592. FIG. 5E illustrates the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 5701 in one of the virtual network(s) 592 of FIG. 5D, according to some embodiments of the invention. FIG. 5E shows that in this virtual network, the NE 5701 is coupled to NE 570D and 570F, which are both still coupled to NE 570E.

FIG. 5F illustrates a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D, according to some embodiments of the invention. Thus, the abstraction of a NE or VNE can span multiple NDs.

While some embodiments of the invention implement the centralized control plane 576 as a single entity (e.g., a single instance of software running on a single electronic device), alternative embodiments may spread the functionality across multiple entities for redundancy and/or scalability purposes (e.g., multiple instances of software running on different electronic devices).

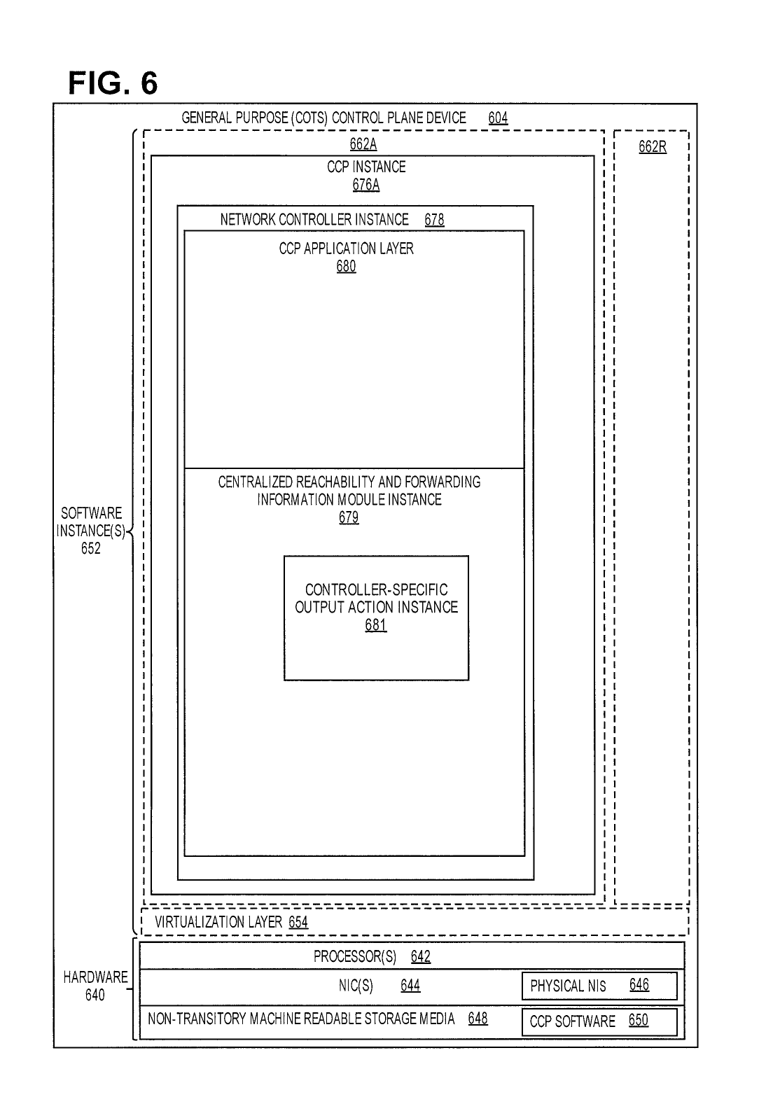

Similar to the network device implementations, the electronic device(s) running the centralized control plane 576, and thus the network controller 578 including the centralized reachability and forwarding information module 579, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 6 illustrates, a general purpose control plane device 604 including hardware 640 comprising a set of one or more processor(s) 642 (which are often COTS processors) and network interface controller(s) 644 (NICs; also known as network interface cards) (which include physical NIs 646), as well as non-transitory machine readable storage media 648 having stored therein centralized control plane (CCP) software 650.

In embodiments that use compute virtualization, the processor(s) 642 typically execute software to instantiate a virtualization layer 654 and software container(s) 662A-R (e.g., with operating system-level virtualization, the virtualization layer 654 represents the kernel of an operating system (or a shim executing on a base operating system) that allows for the creation of multiple software containers 662A-R (representing separate user space instances and also called virtualization engines, virtual private servers, or jails) that may each be used to execute a set of one or more applications; with full virtualization, the virtualization layer 654 represents a hypervisor (sometimes referred to as a virtual machine monitor (VMM)) or a hypervisor executing on top of a host operating system, and the software containers 662A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in embodiments where compute virtualization is used, during operation an instance of the CCP software 650 (illustrated as CCP instance 676A) is executed within the software container 662A on the virtualization layer 654. In embodiments where compute virtualization is not used, the CCP instance 676A on top of a host operating system is executed on the “bare metal” general purpose control plane device 604. The instantiation of the CCP instance 676A, as well as the virtualization layer 654 and software containers 662A-R if implemented, are collectively referred to as software instance(s) 652.

In some embodiments, the CCP instance 676A includes a network controller instance 678. The network controller instance 678 includes a centralized reachability and forwarding information module instance 679 (which is a middleware layer providing the context of the network controller 578 to the operating system and communicating with the various NEs), and an CCP application layer 680 (sometimes referred to as an application layer) over the middleware layer (providing the intelligence required for various network operations such as protocols, network situational awareness, and user-interfaces). At a more abstract level, this CCP application layer 680 within the centralized control plane 576 works with virtual network view(s) (logical view(s) of the network) and the middleware layer provides the conversion from the virtual networks to the physical view. In one embodiment, the centralized reachability and forwarding information module instance 679 may include a controller-specific output action instance 681 for performing embodiments of the controller-specific output action processes described herein above.

The centralized control plane 576 transmits relevant messages to the data plane 580 based on CCP application layer 680 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 580 may receive different messages, and thus different forwarding information. The data plane 580 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 580, the packet (or a subset of the packet header and content) is typically forwarded to the centralized control plane 576. The centralized control plane 576 will then program forwarding table entries into the data plane 580 to accommodate packets belonging to the flow of the unknown packet. Once a specific forwarding table entry has been programmed into the data plane 580 by the centralized control plane 576, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

While the invention has been described in terms of several embodiments, those skilled in the art will recognize that the invention is not limited to the embodiments described, but can be practiced with modification and alteration within the spirit and scope of the appended claims and descriptions provided herein. The description is thus to be regarded as illustrative instead of limiting.

What is claimed is:

1. A method performed by a network device for performing controller-specific output actions, the network device coupled to a plurality of controllers in a software defined network, the method comprising:
receiving a controller identifier advertisement from a controller of the plurality of controllers;
associating the controller identifier with a communication channel to the controller;
generating a flow entry that includes a packet matching criteria and an output action that specifies the controller identifier;
receiving a packet;
determining whether the packet matches the packet matching criteria of the flow entry; and
upon determining that the packet matches the packet matching criteria of the flow entry, determining the communication channel associated with the controller identifier specified by the output action of the flow entry and transmitting the packet to the controller via the communication channel.

2. The method of claim 1, further comprising:
receiving a request from the controller to identify features supported by the network device; and
transmitting a response to the controller identifying the features supported by the network device, wherein the identified features include a controller-specific output action.

3. The method of claim 1, wherein the packet matching criteria is associated with a service.

4. The method of claim 3, wherein the service is one of an Address Resolution Protocol (ARP) service, a Link Layer Discovery Protocol (LLDP) service, and a Dynamic Host Configuration Protocol (DHCP) service.

5. The method of claim 1, wherein the packet matching criteria matches packets to be diagnosed, and wherein the controller runs a diagnostic application.

6. The method of claim 1, wherein the network device includes a second flow entry, wherein the second flow entry includes a second packet matching criteria and a second output action that specifies a second controller identifier advertised by a second controller of the plurality of controllers.

7. The method of claim 6, further comprising:
receiving a second packet;
determining whether the second packet matches the second packet matching criteria of the second flow entry; and
upon determining that the second packet matches the second packet matching criteria of the second flow entry, determining a second communication channel associated with the second controller identifier specified by the second output action of the second flow entry and transmitting the second packet to the second controller via the second communication channel.

8. The method of claim 1, wherein the network device communicates with the controller using an extension to OpenFlow.

9. A network device configured to perform controller-specific output actions in a software defined network that is managed by a plurality of controllers, the network device comprising:
a non-transitory machine readable storage medium to store a controller-specific output action component; and
a processor communicatively coupled to the non-transitory machine readable storage medium, the processor configured to execute the controller-specific output action component, wherein the controller-specific output action component is configured to associate a controller identifier with a communication channel to a controller of the plurality of controllers that advertised the controller identifier, generate a flow entry that includes a packet matching criteria and an output action that specifies the controller identifier, determine whether a received packet matches the packet matching criteria of the flow entry, and upon a determination that the packet matches the packet matching criteria of the flow entry, determine the communication channel associated with the controller identifier specified by the output action of the flow entry for transmitting the packet to the controller.

10. A non-transitory computer readable medium having instructions stored therein to be executed by a network device for performing controller-specific output actions when the network device is coupled to a plurality of controllers in a software defined network, the instructions when executed by the network device cause the network device to perform a set of operations comprising:
receiving a controller identifier advertisement from a controller of the plurality of controllers;
associating the controller identifier with a communication channel to the controller;
generating a flow entry that includes a packet matching criteria and an output action that specifies the controller identifier;
receiving a packet;
determining whether the packet matches the packet matching criteria of the flow entry; and
upon determining that the packet matches the packet matching criteria of the flow entry, determining the communication channel associated with the controller identifier specified by the output action of the flow entry and transmitting the packet to the controller via the communication channel.

11. The non-transitory computer readable medium of claim 10, wherein the instructions when executed by the network device cause the network device to perform a further set of operations comprising:
receiving a request from the controller to identify features supported by the network device; and
transmitting a response to the controller identifying the features supported by the network device, wherein the identified features include a controller-specific output action.

12. The non-transitory computer readable medium of claim 10, wherein the packet matching criteria is associated with a service.

13. The non-transitory computer readable medium of claim 12, wherein the service is one of an Address Resolution Protocol (ARP) service, a Link Layer Discovery Protocol (LLDP) service, and a Dynamic Host Configuration Protocol (DHCP) service.

14. The non-transitory computer readable medium of claim 10, wherein the packet matching criteria matches packets to be diagnosed, and wherein the controller runs a diagnostic application.

15. The non-transitory computer readable medium of claim 10, wherein the network device includes a second flow entry, wherein the second flow entry includes a second packet matching criteria and a second output action that specifies a second controller identifier advertised by a second controller of the plurality of controllers.

16. The non-transitory computer readable medium of claim 15, wherein the instructions when executed by the network device cause the network device to perform a further set of operations comprising:
receiving a second packet;
determining whether the second packet matches the second packet matching criteria of the second flow entry; and
upon determining that the second packet matches the second packet matching criteria of the second flow entry, determining a second communication channel associated with the second controller identifier specified by the second output action of the second flow entry and transmitting the second packet to the second controller via the second communication channel.

17. The non-transitory computer readable medium of claim 10, wherein the network device communicates with the controller using an extension to OpenFlow.

18. A computing device implementing a plurality of software containers for implementing network function virtualization (NFV), wherein a software container from the plurality of software containers is configured to implement a virtual switch that performs controller-specific output actions in a software defined network that is managed by a plurality of controllers, the computing device comprising:
a storage medium to store a controller-specific output action component; and
a processor communicatively coupled to the storage medium, the processor configured to execute the software container, where the software container is configured to implement the controller-specific output action component, the controller-specific output action component configured to associate a controller identifier with a communication channel to a controller of the plurality of controllers that advertised the controller identifier, generate a flow entry that includes a packet matching criteria and an output action that specifies the controller identifier, determine whether a received packet matches the packet matching criteria of the flow entry, and upon a determination that the packet matches the packet matching criteria of the flow entry, determine the communication channel associated with the controller identifier specified by the output action of the flow entry for transmitting the packet to the controller.

19. A method performed by a controller in a software defined network for supporting controller-specific output actions, the method comprising:
transmitting a controller identifier advertisement to a network device; and
transmitting an instruction to the network device to generate a flow entry that includes a packet matching criteria and an output action that specifies a controller identifier of one of a plurality of controllers in the software defined network.

20. The method of claim 19, wherein the packet matching criteria and output action of the flow entry is defined by a network administrator of the software defined network.

21. A control plane device configured to implement at least one centralized control plane for a software defined network, the centralized control plane configured to support controller-specific output actions, the control plane device comprising:
a non-transitory machine readable storage medium to store a controller-specific output action component; and
a processor communicatively coupled to the non-transitory machine readable storage medium, the processor configured to execute the controller-specific output action component, wherein the controller-specific output action component is configured to cause a controller identifier advertisement to be transmitted to a network device and cause an instruction to be transmitted to the network device to generate a flow entry that includes a packet matching criteria and an output action that specifies a controller identifier of one of a plurality of controllers in the software defined network.
